(19) United States
(12) Patent Application Publication
(10) Pub. No.: US 2014/0032009 A1
(43) Pub. Date: Jan. 30, 2014

(54) POWER DISTRIBUTION SYSTEM AND METHOD FOR OPERATION THEREOF

(71) Applicants: Jaroslaw Kussyk, Wien (AT); Johann Lichtnekert, Wien (AT)

(72) Inventors: Jaroslaw Kussyk, Wien (AT); Johann Lichtnekert, Wien (AT)

(73) Assignee: SIEMENS AKTIENGESELLSCHAFT, MUENCHEN (DE)

(21) Appl. No.: 14/111,220

(22) PCT Filed: Apr. 15, 2011
(86) PCT No.: PCT/EP2011/056019

§ 371 Date: Oct. 11, 2013

(51) Int. Cl. G05F 1/66

(52) U.S. Cl. CPC G05F 1/66
USPC 700/297

(57) ABSTRACT

A method controls the power generation of at least one power output device. A control device that is associated with the power output device is connected via a unidirectional or bidirectional communication link to a central device that monitors a power distribution system. Regular or irregular checks on whether the communication link is interrupted or the transmission quality of the communication link is below a prescribed minimum quality value are performed. The supply of power from the at least one power output device to the power distribution system is reduced or stopped by the control device if the communication link is interrupted or the transmission quality of the communication link is below the prescribed minimum quality value.

The invention relates to a method for controlling the power generation of at least one power output device that is connected to the power distribution system.

With an increasing decentralization of power generation (for example by photovoltaic plants or small thermal power-heat coupling systems, especially in private households) the type of usage of the distribution networks is changing from a centralized power distribution (from one or more transformer stations in the direction of the power consumer) into an at least at times decentralized power distribution (e.g. from one household to other households or from a number of private power generators in the direction of transformer stations or into the medium-voltage network). In the future it will be possible to store surplus power at individual network users, for example in batteries of electric cars that are not completely charged.

By monitoring the current distribution as well as the voltage quality in the power distribution systems the respective current load on the individual distribution system lines can be detected and, when possible, the switching status of the distribution systems or their topology adapted accordingly.

Most of the low-voltage distribution systems were often planned and constructed years ago or even decades ago. The ensuing period saw a further evolutionary development of the distribution systems, which changed the topology of the networks through additions, conversions and expansions. The documentation about the topology of the networks has often not been kept fully up-to-date. Added to this is the fact that switchable disconnection points (switching devices) are usually provided within low-voltages networks, for example for switching over of networks during service work, which have often not coped with the demands of decentralized power generation.

Although the proportion of decentrally generated power is growing constantly, in many places it is still often relatively low. This means that in practice the dimensioning reserve of the distribution systems is exhausted for the time being or the voltage quality is being monitored by spot checking, especially in low-voltage distribution networks. In addition it is assumed that the power, especially generated in a low-voltage system, is proportionally less than the simultaneous power consumption of other system users.

The underlying object of the invention is to specify a method for controlling a power supply system which can guarantee robust and safe operation even in the event of a fault.

This object is achieved according to the invention by means of a method having the features cited in claim 1. Advantageous embodiments of the inventive method are disclosed in sub-claims.

Accordingly a method for controlling a power distribution system is provided in accordance with the invention, in which a control device assigned to a power output device has a unidirectional or bidirectional communication link to a central device that monitors a power distribution system and a check is performed at regular or irregular intervals as to whether the communication link is interrupted or whether the transmission quality of the communication link falls below a prescribed minimum quality value, and the supply of power of the at least one power output device into the power distribution system is reduced or stopped if the communication device is interrupted or the transmission quality of the communication link is below the prescribed minimum quality value.

A significant advantage of the inventive method is for example that it allows an excessive supply of power into the power distribution system to be avoided in the event of a fault. If for example an interruption of communication links results in power output devices not being able to be controlled or at least not being able to be sufficiently controlled any longer by the higher-ranking central device, the power distribution network it is transferred into a “safe” state in which the supply of power of those power output devices which are not able to be reached or can only be reached with difficulty by the central device, are shut down. This avoids too much power being fed unchecked into the power distribution system and said system getting into an unstable state.

The power output devices can for example involve power generation devices or power storage devices.

It is viewed as especially advantageous for the central device to control the control device and thus indirectly the supply of power of the power output device for as long as the communication link is in existence or the transmission quality of the communication link reaches or exceeds the prescribed minimum quality value. So long as sufficiently good communication is namely possible between the central device and the local control devices, the power distribution system can be controlled directly by the central device.

If the communication link between the central device and one or more of the control devices is interrupted or the transmission quality of the communication links falls below the prescribed minimum quality value, the control devices involved can for example reduce or throttle the power generation of the power generation devices connected to them. As an alternative the control devices affected by the communication outage can also divert the power generation devices connected to them entirely or partly into assigned power storage devices and store the power there.

If power consumption devices that can be switched in are available, the control devices affected by a communication outage can also connect the power generation devices connected to them to such switchable power consumption devices and consume the power of the power generation devices entirely or partly with the power consumption devices.

In addition, in accordance with a further advantageous embodiment of the inventive method there can be provision for the central device to increase, reduce or stop the electrical supply of power of at least one further power output device which is different from that power output device in respect of which the interruption of the communication link or the drop in transmission quality below the prescribed minimum quality value has been detected and/or to throttle or to switch off the electrical power consumption of a power consumption device connected to the other distribution system area.

In this case advantageous use is made of the fact that the central device knows that the local control devices are making every attempt to switch into a safe operating state in the event of a communication outage. Consequently the central device can additionally carry out suitable measures in order to positively influence system stability. This can for example be done by explicitly influencing the supply of power of a further power output device in another distribution system area for which no communication outage has been detected, or by rejecting the electrical loads. In such cases however—e.g. by monitoring a system voltage and/or a system load of the power supply lines—it must be ensured that the measures themselves have no negative effects on the system stability.

The invention additionally relates to an arrangement with at least one power output device and a control device assigned to the at least one power output device which is suitable for controlling supplying the power of the power output device into a power distribution system.

In accordance with the invention there is provision for the control device to be connected to a central device in a unidirectional or bidirectional communication link and for the control device to be embodied such that it reduces or stops the supply of power into the power distribution system by the at least one power output device if the communication link is interrupted or if the transmission quality of the communication link is below a prescribed minimum quality value.

With regard to the advantages of the arrangement according to the invention the reader is referred to the statements made hereintofore in connection with the method according to the invention, since the advantages of the inventive method substantially correspond to those of the inventive arrangement.

If the power output device involves a power generation device, the control device can for example reduce or stop the power generation of the power generation device if the communication link is interrupted or if the transmission quality of the communication link is below the prescribed minimum quality value.

If the power output device involves a power generation device and the arrangement additionally has a power storage device, the control device will preferably divert the power of the power generation device entirely or partly into the power storage device and store it there if the communication link is interrupted or if the transmission quality of the communication link is below the prescribed minimum quality value.

If the arrangement has one or more power consumption devices that can be switched in it is viewed as advantageous for the control device to connect the switchable power consumption device to the at least one power output device and to consume the power of the at least one power output device entirely or partly with the power consumption device if the communication link is interrupted or the transmission quality of the communication link is below the prescribed minimum quality value.

The power distribution system can for example involve a low-voltage distribution system.

The invention is explained in more detail below with reference to exemplary embodiments; in the figures, by way of example,

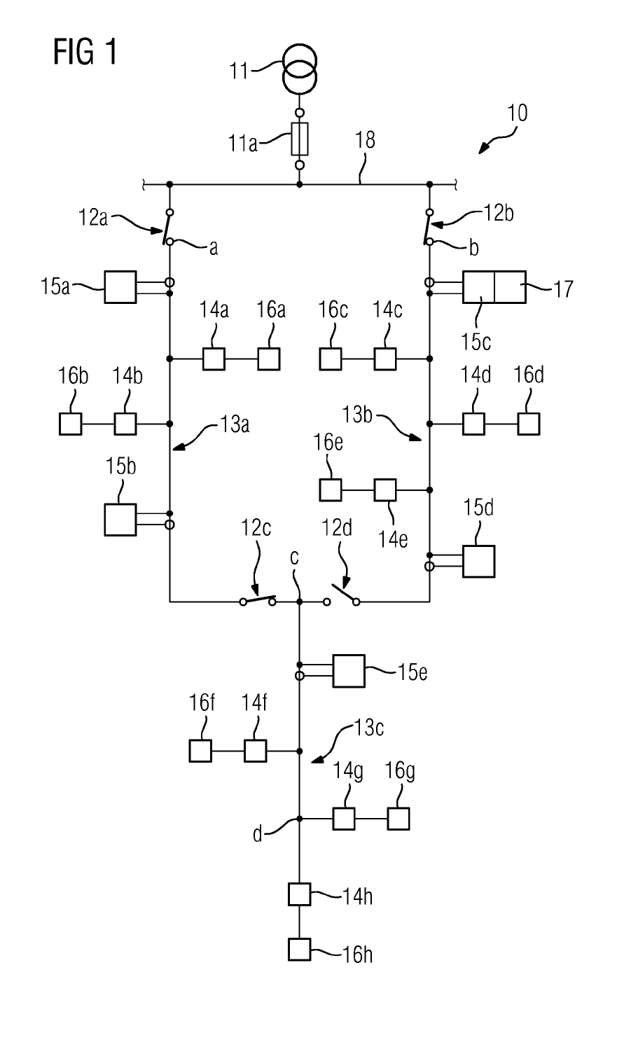

FIG. 1 shows an exemplary embodiment for an inventive arrangement, with reference to which the inventive method is also explained by way of example, and

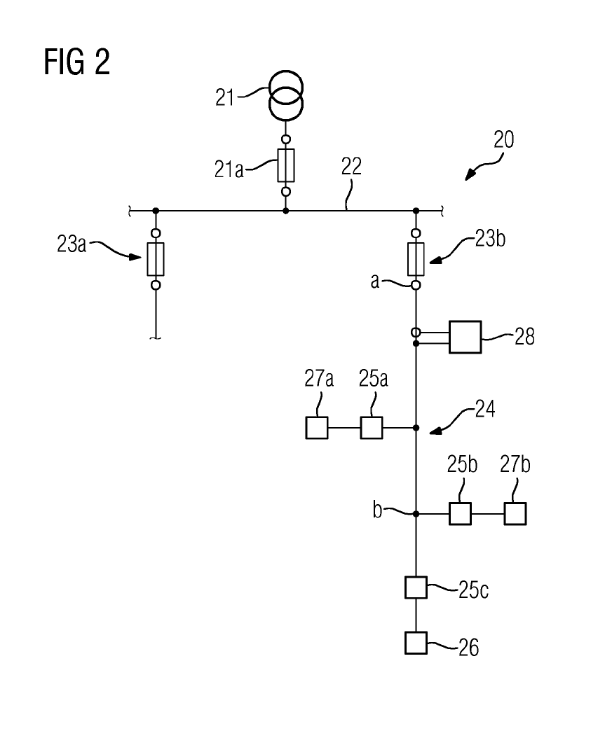

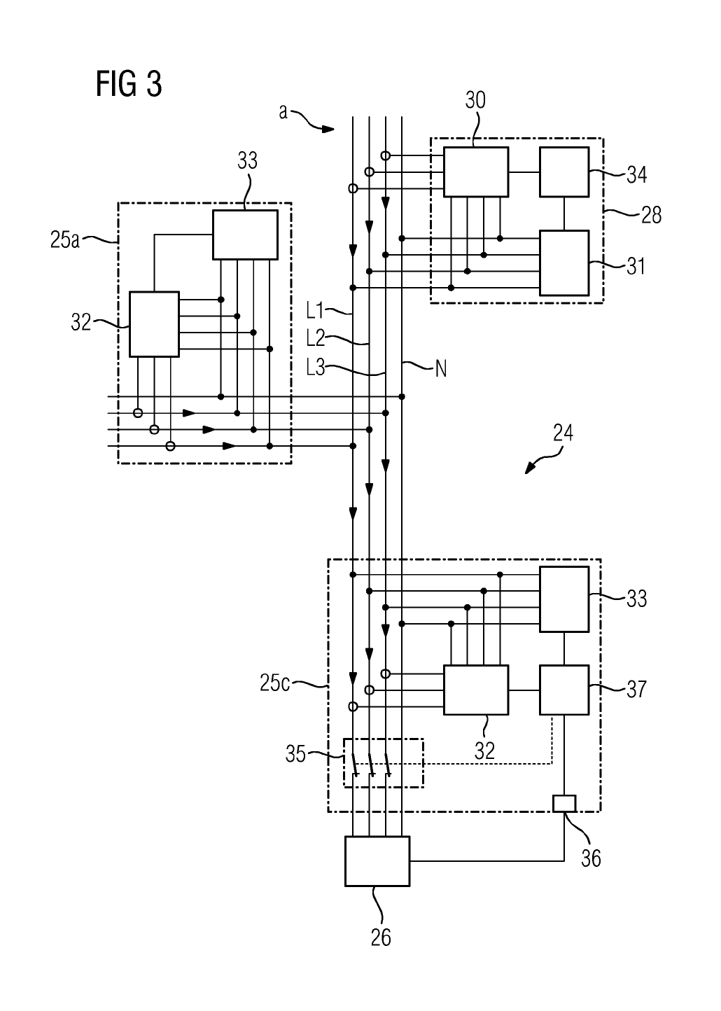

FIGS. 2-3 show a further exemplary embodiment for an inventive arrangement with reference to which a further exemplary embodiment for the inventive method is explained.

FIG. 1 shows an exemplary embodiment for an arrangement for monitoring and/or controlling the power distribution in a part area of a three-phase power system with decentralized power supply and/or storage. A distribution system 10 comprises a power transformer 11 with a transformer fuse 11a, a bus bar 18 with switching devices 12a and 12b closed in FIG. 1 as well as distribution system phase conductors 13a (between points a and c), 13b (between points b and c) and 13c (between points c and d). In the overview diagram in FIG. 1 the power phases along with all the associated elements are shown as a line bundle, which are intended to symbolize the phase lines L1 to L3 and the neutral conductor.

Distribution system users are connected to the distribution system 10 by means of power meters 14a to 14h. In the network topology shown in FIG. 1 the power phase 13c is connected to the phase 13a by means of a closed switching device 12c. A switching device 12d is opened so that the power phases 13b and 13c are separated from one another.

To monitor the power phases 13a-13c current and/or voltage measurement devices 15a to 15e are installed in the distribution system 10, which divide the distribution system topology into three system areas.

The distribution system users involve power generation devices 16d, 16g and 16h, power storage devices 16a, 16e, 16f and power consumption devices 16b and 16c for example. A local control device—not explicitly shown in FIG. 1—is integrated in each case into the power generation devices 16d, 16g and 16h and the power storage devices 16a, 16e and 16f. The local control devices have the task of locally controlling the respective assigned power generation device 16d, 16g and 16h or power storage device 16a, 16e, 16f.

An integration of the control devices into the power generation devices 16d, 16g and 16h or into the power storage devices 16a, 16e, 16f is only to be understood here as an example. Instead of this the control devices can also form separate devices which are separate from the power generation devices 16d, 16g and 16h or power storage devices 16a, 16e, 16f to be controlled. It is also possible for one or more control devices to be assigned in each case to one or more power generation devices 16d, 16g and 16h, one or more power storage devices 16a, 16e, 16f and/or one or more power consumption devices 16b and 16c.

The control devices are connected to a central device 17 for network management via the unidirectional of bidirectional communication links not shown in any greater detail in FIG. 1 for reasons of clarity. The central device 17 is located in the current and/or voltage measurement device 15c for example. The communication signals of the communication links can be transmitted by means of a PLC (PLC=Power Line Communication) method via the distribution system 10 or via a separate communication network.

The measurement data of the current and/or voltage measurement devices 15a to 15e arrive at the central device 17, which evaluates the measurement data and controls the power generation devices 16d, 16g and 16h as well as the power storage devices 16a, 16e, 16f centrally. To this end the central device 17 activates the local control devices which are assigned to the power generation devices 16d, 16g and 16h as well as the power storage devices 16a, 16e, 16f. The control signals are transmitted from the central device 17 via the aforementioned communication links. In this way the central device 17 can control the flow of power in the system phases 13a, 13b and 13c separately from one another by an explicit increase or throttling of the power generation in the individual areas of the system and if necessary by a temporary storage of power. Such control is however only possible while the communication links exist or the transmission quality of the communication links reaches or exceeds a prescribed minimum quality value.

If one or more communication links are interrupted or the transmission quality of the transmission links is below a prescribed minimum quality, the local control devices will themselves take over the activation of the assigned power generation devices 16d, 16g and 16h and of the power storage devices 16a, 16e, 16f and will do so such that the distribution system 10 is transferred to a stable, safe state.

If a control device of a power generation device 16d, 16g, 16h is affected by a communication problem, the control device involved will preferably reduce or stop the power generation of the power generation device 16d, 16g, 16h as soon as the communication link is interrupted or the transmission quality of the communication link is below a prescribed minimum quality value.

If a control device affected by a communication problem is assigned to power generation device 16d, 16g, 16h and a power storage device 16a, 16e, 16f, the control device can throttle the power of the power generation device 16d, 16g, 16h and/or divert it into the power storage device 16a, 16e, 16f and store it there, as soon as the communication link is interrupted or the transmission quality of the communication link is below a prescribed minimum quality value.

If a control device affected by a communication problem is assigned to a power generation device 16d, 16g, 16h and a power consumption device 16b, 16c, the control device can throttle the power generation of the power generation device 16d, 16g, 16h and/or switch in the power consumption device 16b, 16c and consume the power of the power generation device 16d, 16g, 16h entirely or partly with the power consumption device 16b, 16c, if the communication link is interrupted or the transmission quality of the communication link is below a prescribed minimum quality value.

If a control device affected by communication problem is only assigned to one or more power storage devices 16a, 16e, 16f, the control device will preferably keep the power stored and avoid supplying it into the distribution system.

In summary the arrangement in accordance with FIG. 1 allows control of the power distribution to the individual distribution system areas/sections which are delimited by the current and/or voltage measurement devices 15a to 15e. The power flow in the system can be primarily controlled by the local storage of the surplus power at the system users of individual system areas and the retrieval of the stored power during a lack of locally-generated power or by a throttling of power production during a production surplus and power transport capacity not available in the distribution system. In such cases the current quantity of power stored at the system users is monitored permanently by the central device 17. In the event of an outage of communication links the distribution system 10 is preferably stabilized by a locally-controlled throttling of the supply of power.

FIGS. 2 and 3 show a further exemplary embodiment for an arrangement for monitoring and/or regulating the power distribution in a part area of a three-phase system with decentralized supply of power and/or power storage. A distribution system 20 consists of a power transformer 21 with a transformer fuse 21a, a bus bar 22 with branch circuit devices 23a and 23b, of which only one is shown in greater detail in FIG. 2 and is identified by the reference character 24 (between points a and b).

The individual distribution system users are connected by means of power meters 25a to 25c to the system 20, wherein the power meter 25c has a 3-phase controllable current generator 26 connected upstream of it. The distribution system users 27a and 27b can involve any given power generation devices, power storage devices or power consumption devices. In addition to the monitoring of the power phase 24, a current and/or voltage measurement device 28 is installed in the system 20. The overview diagram in FIG. 2 shows the power phases along with all associated elements as a line bundle, which is intended to symbolize the phase lines L1 to L3 and the neutral conductor.

The distribution system area with the power phase 24 is shown in greater detail in FIG. 3. For reasons of clarity this figure does not show the system user 27b and the power meter 25b. The current and/or voltage measurement device 28 consists of an apparatus 30 for detecting and processing currents and/or voltages and a communication apparatus 31 which is connected to phase conductors L1, L2 and L3 and/or the neutral conductor and communicates via these.

The power meters 25a and 25c (as mentioned power meter 25b is not shown) each contain an apparatus 32, which in addition to the actual power metering, also carries out a detection and processing of currents and/or voltages of individual phase conductors L1, L2, l3, and a communication apparatus 33 in each case.

The power meters 25a and 25c communicate with the current and/or voltage measurement device 28, especially with a central device 34 which is contained in current and/or voltage measurement device 28 and monitors the power phase 24 inter alia.

The power meter 25c additionally contains a switch-off device 35 and a control interface 36 to the power generator 26 connected to a control unit 37, which has a 3-phase connection via the power meter 25c to the network.

In accordance with the exemplary embodiment shown in FIG. 3, the central control unit 34 in the current and/or voltage measurement device 28 periodically sends out control telegrams via the communication apparatus 31 to the control unit 37 in the power meter 25c which contain required prescribed values for the power generators 26. Based on the values, the control unit 37 controls the power generation in the current generator 26 via the control interface 36 and monitors the operating state of the power generator 26 via the same control interface 36.

If the communication link between the central device 34 and the control unit 37 fails permanently, the control unit 37 controls the power generator 26 in a safe mode.

If the control interface 36 between the control unit 37 and the power generator 26 fails, the system connection of the power generator 26 will be disconnected by means of the switch-off device 35, in order to deflect possible greater damage at the power generator 26 or a possible system short-circuit.

In addition to the method of operation explained in FIGS. 1 to 3, if it detects a communication fault, the central device can also take measures itself to stabilize the power network. In such cases it can either increase, reduce or stop the supply of power into the distribution system or eject controllable loads from the distribution system.

1-12. (canceled)

13. A method for controlling power generation by at least one power output device, which comprises the steps of:
connecting a control device assigned to the power output device to a central device monitoring a power distribution system via a communication link selected from the group consisting of a unidirectional communication link and a bidirectional communication link;
performing regular or irregular checks as to whether the communication link is interrupted or a transmission quality of the communication link is below a prescribed minimum quality value; and
reducing or stopping a supply of power of the at least one power output device into the power distribution network via the control device if the communication link is interrupted or the transmission quality of the communication link is below the prescribed minimum quality value, the central device controls the control device and thus indirectly the supply of the power of the power output device, provided the communication link exists or the transmission quality of the communication link reaches or exceeds the prescribed minimum quality value.

14. The method according to claim 13, which further comprises selecting the power output device from the group consisting of a power generation device and a power storage device.

15. The method according to claim 14, which further comprises reducing or stopping, via the control device, a power generation of the power generation device if the communication link is interrupted or the transmission quality of the communication link is below the prescribed minimum quality value.

16. The method according to claim 13, which further comprises diverting, via the control device, the power of the at least one power output device being at least one power generation device entirely or in part into a power storage device and storing the power in the power storage device if the communication link is interrupted or the transmission quality of the communication link is below the prescribed minimum quality value.

17. The method according to claim 14, which further comprises connecting a connectable power consumption device to the at least one power generation device, the control device connects the connectable power consumption device and consumes the power of the power generation device entirely or in part with the connectable power consumption device if the communication link is interrupted or the transmission quality of the communication link is below the prescribed minimum quality value.

18. The method according to claim 13, wherein the central device increases, reduces or stops an electrical supply of power of at least one further power output device which is different from the power output device in respect of which an interruption of the communication link or a reduction of the transmission quality below the prescribed minimum quality value has been recognized and/or throttles or switches off electrical power consumption of a power consumption device connected to another distribution system area.

19. A configuration, comprising:
at least one power output device for generating power;
a control device assigned to said at least one power output device and controlling a feeding of the power of said power output device into a power distribution network;
a communication link selected from the group consisting of a unidirectional communication link and a bidirectional communication link;
a central device connected to said control device via said communication link;
said control device reducing or stopping a supply of the power into the power distribution system by said at least one power output device if said communication link is interrupted or a transmission quality of said communication link is below a prescribed minimum quality value; and
said control device and thus indirectly a supply of the power of said power output device is able to be controlled via said communication link, provided said communication link exists or the transmission quality of said communication link reaches or exceeds the prescribed minimum quality value.

20. The configuration according to claim 19, wherein:
said power output device is a power generation device; and
said control device reduces or stops power generation of said power generation device if said communication link is interrupted or the transmission quality of said communication link is below the prescribed minimum quality value.

21. The configuration according to claim 19,
wherein said power output device is a power generation device;
further comprising a power storage device; and
wherein said control device diverts the power of said power generation device entirely or in part into said power storage device if said communication link is interrupted or the transmission quality of said communication link is below the prescribed minimum quality value.

22. The configuration according to claim 19,
further comprising a connectable power consumption device; and
wherein said control device connects said connectable power consumption device to said at least one power output device and consumes the power of said at least one power output device entirely or in part with said power consumption device if said communication link is interrupted or the transmission quality of said communication link is below the prescribed minimum quality value.

23. The configuration according to claim 19, wherein the power distribution system is a low voltage distribution system.
